(19) United States
(12) Patent Application Publication
(10) Pub. No.: US 2024/0333872 A1
(43) Pub. Date: Oct. 3, 2024

(54) DETERMINING VISUAL ITEMS FOR PRESENTATION IN A USER INTERFACE OF A VIDEO CONFERENCE

(71) Applicant: Google LLC, Mountain View, CA (US)

(72) Inventor: Stefan Lindmark, Östhammar (SE)

(21) Appl. No.: 18/128,109

(22) Filed: Mar. 29, 2023

(51) Int. Cl. H04N 7/15; G06F 3/04845

(52) U.S. Cl. CPC H04N 7/15; G06F 3/04845

(57) ABSTRACT

Systems and methods for determining visual items for presentation in a user interface (UI) of a video conference are provided. A UI is provided for presentation on a first client device of a plurality of client devices of a plurality of participants of the video conference, wherein the UI comprises a plurality of regions to display a plurality of visual items each corresponding to one of a plurality of video streams from the plurality of client devices. One or more events associated with the plurality of participants of the video conference are identified. A first subset of the plurality of visual items that satisfy one or more screen invisibility criteria is determined based on the one or more events. Each visual item of the first subset is caused to be invisible in the UI. At least one of remaining visual items is caused to be rearranged in the UI.

### TECHNICAL FIELD

Aspects and implementations of the present disclosure relate to determining visual items for presentation in a user interface of a video conference.

### BACKGROUND

Video conferences can take place between multiple participants via a video conference platform. A video conference platform includes tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the video conference platform can provide a user interface that includes multiple regions to display the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes providing, for presentation on a first client device of a plurality of client devices of a plurality of participants of a video conference, a user interface (UI). The user interface includes a plurality of regions to display a plurality of visual items each corresponding to one of a plurality of video streams from the plurality of client devices. The method further includes identifying one or more events associated with the plurality of participants of the video conference. The method further includes determining, based on the one or more events, a first subset of the plurality of visual items that satisfy one or more screen invisibility criteria. The method further includes causing each visual item of the first subset to be invisible in the UI, and causing at least one of remaining visual items to be rearranged in the UI.

In some implementations, to cause the at least one of the remaining visual items to be rearranged in the UI, the method includes increasing a size of a remaining region displaying the at least one of the remaining visual items to occupy at least a part of a region that displayed a visual item of the first subset that was caused to be invisible in the UI.

In some implementations, the one or more events include detection of a low audio volume level associated with a first client device of the plurality of client devices. To determine the first subset of the plurality of visual items that satisfy the one or more screen invisibility criteria, the method includes determining that an audio volume level associated with the first client device satisfies a low audio volume criterion for a defined period of time. In some implementations, the determining is based on a timer associated with the first client device to measure a period of time during which the audio volume level associated with the first client device is below a threshold audio volume for the defined period of time. The method further includes adding a visual item corresponding to the video stream from the first client device to the first subset.

In some implementations, to cause the at least one of the remaining visual items to be rearranged in the UI, the method includes determining a second subset of the plurality of visual items that do not satisfy the one or more screen invisibility criteria. The method further includes modifying a position or a size of one or more of the second subset of the plurality of visual items.

In some embodiments, the one or more events include detection of a high audio volume level associated with the plurality of client devices. To determine the second subset of the plurality of visual items that do not satisfy the one or more screen invisibility criteria, the method includes comparing an audio volume level associated with a first client device of the plurality of client devices to an audio volume level associated with each other client device of the plurality of client devices. The method further includes determining, based on the comparing, that the audio volume level associated with the first client device is a highest audio volume level as compared to each other client device of the plurality of client devices for a threshold period of time. In some implementations, the determining is based on a timer associated with the first client device to measure a period of time during which the audio volume level associated with the first client device is higher than an audio volume level of each other client device of the plurality of client devices for the threshold period of time. The method further includes adding a visual item corresponding to the video stream from the first client device to the second subset of the plurality of visual items.

In some implementations, to cause each visual item of the first subset to be invisible in the UI, the method further includes causing each respective region that displayed a visual item of the first subset to become hidden on the UI.

In some implementations, to cause each visual item of the first subset to be invisible in the UI, the method further includes causing each respective region that displayed a visual item of the first subset to be removed from the UI.

In some implementations, the one or more events include detection of an audio mute signal. To determine the first subset of the plurality of visual items that satisfy the one or more screen invisibility criteria, the method includes receiving the audio mute signal from a first client device of the plurality of client devices. The method further includes, in response to receiving the audio mute signal, setting a timer associated with the first client device to initiate a countdown from an initial value. The method further includes, in response to determining that the timer reaches a threshold value, adding a visual item corresponding to the video stream from the first client device to the first subset. The method further includes resetting the timer associated with the first client device.

In some implementations, the one or more events include detection of an audio mute signal. To determine the first subset of the plurality of visual items that satisfy the one or more screen invisibility criteria, the method includes receiving the audio mute signal from a host of the video conference. The method further includes identifying a first client device of the plurality of client devices associated with the audio mute signal received from the host of the video conference. The method further includes, in response to receiving the audio mute signal: identifying a first client device of the plurality of client devices associated with the audio mute signal, and setting a timer associated with the first client device to initiate a countdown from an initial value. In response to determining that the timer reaches a threshold value, the method further includes adding a visual item corresponding to the video stream from the first client device to the first subset. The method further includes resetting the timer associated with the first client device.

In some implementations, the one or more events include a user selection of a UI element to remove a visual item from the UI. To determine the first subset of the plurality of visual items that satisfy the one or more screen invisibility criteria, the method includes identifying a client device associated with the visual item selected to be removed. The method further includes adding a visual item corresponding to the video stream from the identified client device to the first subset.

In some implementations, the one or more events include a user selection of a UI element to adjust a maximum number of visual items displayed in the UI. To determine the first subset of the plurality of visual items that satisfy the one or more screen invisibility criteria, the method includes setting a timer associated with the audio activity of a first client device of the plurality of client devices in response to determining that an audio volume level of an audio activity of the first client device exceeds a threshold. For each other client device of the plurality of client devices, the method further includes setting a timer associated with an audio activity of each respective client device of each other client device in response to determining that an audio volume level of the audio activity of each other client device exceeds the threshold. The method further includes comparing a current value of the timer associated with the audio activity of the first client device to a current value of the timer associated with the audio activity of each respective client device of each other client device. The method further includes determining, based on the comparing, that the current value of the timer associated with the audio activity of the first client device is a lower value as compared to the current value of the timer associated with the audio activity of each respective client device of each other client device. The method further includes adding a visual item corresponding to the video stream from the first client device to the first subset.

In some implementations, the one or more events include a user selection of a UI element to pin a visual item in the UI. To determine the second subset of the plurality of visual items that do not satisfy the one or more screen invisibility criteria, the method includes identifying a client device associated with the visual item selected to be pinned. The method further includes adding a visual item corresponding to the video stream from the identified client device to the second subset.

An aspect of the disclosure provides a system including a memory device and a processing device communicatively coupled to the memory device. The processing device performs operations including providing, for presentation on a first client device of a plurality of client devices of a plurality of participants of a video conference, a user interface (UI). The user interface includes a plurality of regions to display a plurality of visual items each corresponding to one of a plurality of video streams from the plurality of client devices. The processing device performs operations further including identifying one or more events associated with the plurality of participants of the video conference. The processing device performs operations further including determining, based on the one or more events, a first subset of the plurality of visual items that satisfy one or more screen invisibility criteria. The processing device performs operations further including causing each visual item of the first subset to be invisible in the UI, and causing at least one of remaining visual items to be rearranged in the UI.

In some implementations, to cause the at least one of the remaining visual items to be rearranged in the UI, the processing device performs operations that include increasing a size of a remaining region displaying the at least one of the remaining visual items to occupy at least a part of a region that displayed a visual item of the first subset that was caused to be invisible in the UI.

In some implementations, the one or more events include detection of a low audio volume level associated with a first client device of the plurality of client devices. To determine the first subset of the plurality of visual items that satisfy the one or more screen invisibility criteria, the processing device performs operations that include determining that an audio volume level associated with the first client device satisfies a low audio volume criterion for a defined period of time. In some implementations, the determining is based on a timer associated with the first client device to measure a period of time during which the audio volume level associated with the first client device is below a threshold audio volume for the defined period of time. The processing device performs operations that further include adding a visual item corresponding to the video stream from the first client device to the first subset.

In some implementations, to cause the at least one of the remaining visual items to be rearranged in the UI, the processing device performs operations that include determining a second subset of the plurality of visual items that do not satisfy the one or more screen invisibility criteria. The processing device performs operations that further include modifying a position or a size of one or more of the second subset of the plurality of visual items.

An aspect of the disclosure provides a computer program including instructions that, when the program is executed by a processing device, cause the processing device to perform operations including providing, for presentation on a first client device of a plurality of client devices of a plurality of participants of a video conference, a user interface (UI). The user interface includes a plurality of regions to display a plurality of visual items each corresponding to one of a plurality of video streams from the plurality of client devices. The processing device performs operations further including identifying one or more events associated with the plurality of participants of the video conference. The processing device performs operations further including determining, based on the one or more events, a first subset of the plurality of visual items that satisfy one or more screen invisibility criteria. The processing device performs operations further including causing each visual item of the first subset to be invisible in the UI, and causing at least one of remaining visual items to be rearranged in the UI.

In some implementations, to cause the at least one of the remaining visual items to be rearranged in the UI, the processing device performs operations that include increasing a size of a remaining region displaying the at least one of the remaining visual items to occupy at least a part of a region that displayed a visual item of the first subset that was caused to be invisible in the UI.

In some implementations, the one or more events include detection of a low audio volume level associated with a first client device of the plurality of client devices. To determine the first subset of the plurality of visual items that satisfy the one or more screen invisibility criteria, the processing device performs operations that include determining that an audio volume level associated with the first client device satisfies a low audio volume criterion for a defined period of time. In some implementations, the determining is based on a timer associated with the first client device to measure a period of time during which the audio volume level associated with the first client device is below a threshold audio volume for the defined period of time. The processing device performs operations that further include adding a visual item corresponding to the video stream from the first client device to the first subset.

In some implementations, the one or more events include detection of an audio mute signal. To determine the first subset of the plurality of visual items that satisfy the one or more screen invisibility criteria, the processing device performs operations that include receiving the audio mute signal from a first client device of the plurality of client devices. The processing device performs operations that further include, in response to receiving the audio mute signal, setting a timer associated with the first client device to initiate a countdown from an initial value. The processing device performs operations that further include, in response to determining that the timer reaches a threshold value, adding a visual item corresponding to the video stream from the first client device to the first subset. The processing device performs operations that further include resetting the timer associated with the first client device.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example video conference manager, in accordance with implementations of the present disclosure.

FIG. 3A illustrates an example user interface (UI) of a video conference, in accordance with implementations of the present disclosure.

FIG. 3B illustrates another example UI of a video conference, in accordance with implementations of the present disclosure.

FIG. 4 depicts a flow diagram of a method for determining visual items for presentation in a UI of a video conference, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to determining visual items for presentation in a user interface (UI) of a video conference platform. A video conference platform can enable video-based conferences between multiple participants via respective client devices that are connected over a network and share each other's audio (e.g., voice of a user recorded via a microphone of a client device) and/or video streams (e.g., a video captured by a camera of a client device) during a video conference. In some instances, a video conference platform can enable a significant number of client devices (e.g., up to one hundred or more client devices) to be connected via the video conference.

A participant of a video conference can speak (e.g., present on a topic) to the other participants of the video conference. Some existing video conference platforms can provide a user interface (UI) to each client device connected to the video conference, where the UI displays the video streams shared over the network in a set of regions in the UI. For example, the video stream of a participant who is speaking to the other participants in the video conference can be displayed in a designated region in the UI of the video conference platform. In some instances, participants in the video conference can choose a particular layout for the display of each video stream of participants in the video conference. For example, some video conference platforms can include a layout where a single region is presented in the UI, where the single region displays a video stream of a participant who is actively speaking in the video conference. However, this single region layout often results in frequent switching back and forth between the video stream of each participant who is actively speaking. In addition, the switching back and forth between the actively speaking participants may not be accurate. For example, a participant can accidentally unmute their audio while speaking in the background (e.g., by accidentally clicking on a UI element, such as a button, to unmute their audio), resulting in the single region switching to displaying the video stream of this participant who accidentally unmuted their audio. This can cause distractions in the video conference, such as distracting the other participants who are listening to the presentation and/or discussion by the participant actively speaking.

In another example, some video conference platforms can include a layout where two or more regions are presented in the UI, where each region displays a video stream of each participant who has spoken or is actively speaking. However, there are times during a video conference where a single participant may be speaking for an extended period of time, while other participants, including other participants who previously spoke in the video conference, have not spoken for some time or at all. Thus, when using the two or more regions layout, a video stream of an inactive participant (e.g., a participant who has spoken but has not spoken in a while) can remain in display in the UI. This can cause distractions in the video conference, such as distracting the other participants who are listening to the presentation and/or the discussion being done by the participant speaking. This can also impact the production value of the video conference, such as impacting the available size in the UI to display shared content (e.g., a presentation) from a participant actively speaking in the video conference due to the display of regions that are displaying video streams of inactive participants and are thus taking up unnecessary screen space in the UI. A potential solution to handle these situations can be to allow a host and/or participant in the video conference to remove the video streams of the inactive participants from the UI. However, this can burden the host and/or participant in the video conference with additional tasks, require additional computing resources to support these tasks, and disrupt the video conference flow for the host and/or participants who may be speaking and/or presenting at that time. Further, the host and/or participants are not likely to accurately determine or predict which participants in the video conference should have their video stream displayed in the UI and/or which participants should not have their video stream displayed in the UI. As result, the host and/or participants would need to perform further tasks to ensure that appropriate video streams are presented at various moments during the video conference, which would further result in unnecessary consumption of computing resources, thereby decreasing overall efficiency and increasing overall latency of the video conference platform.

Implementations of the present disclosure address the above and other deficiencies by determining which visual items should be presented in a user interface (UI) at various points in time during a video conference. A user interface can be provided for presentation on each client device of client devices of participants of a video conference, where the user interface can include a set of regions to display visual items that each correspond to a video stream from a respective client device. One or more events associated with the participants of the video conference can be identified (e.g., a detection of a low audio volume level, a detection of a high audio volume level, a detection of an audio mute signal, a user selection of a UI element such as to remove a visual item from the UI and/or to adjust a maximum number of visual items displayed in the UI and/or to pin a visual item in the UI, etc.). Based on the one or more events, a first subset of the visual items that satisfy one or more screen invisibility criteria can be determined. Each visual item of the first subset can then be no longer visible in (e.g., removed or hidden from) the UI, and at least one remaining visual item can be rearranged in the UI (e.g., by moving it to (or closer to) the focus area in the UI). In some embodiments, the size of at least one remaining visual item can be increased to occupy at least a portion of a UI area previously dedicated to presenting one or more visual items that are no longer visible. Thus, the participants of the video conference can efficiently conduct the video conference with a reduced number of distractions due to a more suitable presentation of visual items in the UI that provides appropriate focus on and good visibility of what is being presented and/or who is speaking at particular moments during the video conference.

Aspects of the present disclosure provide technical advantages over previous solutions. Aspects of the present disclosure can provide an additional functionality to the video conference tool of the video conference platform that intelligently brings appropriate content (e.g., visual items) to the attention of participants in a video conference based on one or more events, such as a detection of a low audio volume level, a detection of a high audio volume level, a detection of an audio mute signal, a user selection of a UI element such as to remove a visual item from the UI and/or to adjust a maximum number of visual items displayed in the UI and/or to pin a visual item in the UI, etc., as described in more details herein. Such additional functionality can also result in more efficient use of processing resources utilized to facilitate the connection between client devices by avoiding consumption of computing resources needed to support participants and/or hosts manually managing the display of visual items corresponding to video streams of the participants in the UI, thereby resulting in an increase of overall efficiency and a decrease in overall latency of the video conference platform. In addition, according to some aspects of the disclosure that allow appropriate content (e.g., documents) to occupy more space on the screen, experience of users that participate in video conferences via small-screen devices can be significantly improved.

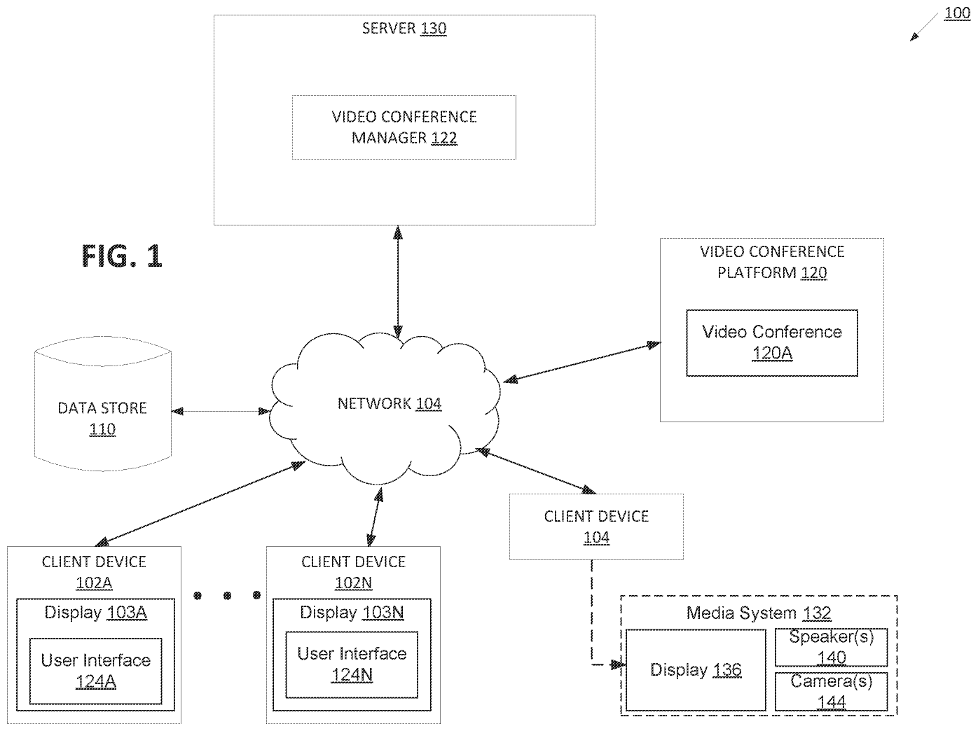

FIG. 1 illustrates an example system architecture 100, in accordance with implementations of the present disclosure. The system architecture 100 (also referred to as “system” herein) includes client devices 102A-N, one or more client devices 104, a data store 110, a video conference platform 120, and a server 130, each connected to a network 104.

In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or video stream data, in accordance with embodiments described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by video conference platform 120 or one or more different machines (e.g., the server 130) coupled to the video conference platform 120 via network 104. In some implementations, the data store 110 can store portions of audio and video streams received from the client devices 102A-102N for the video conference platform 120. Moreover, the data store 110 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents may be shared with users of the client devices 102A-102N and/or concurrently editable by the users.

Video conference platform 120 can enable users of client devices 102A-102N and/or client device(s) 104 to connect with each other via a video conference (e.g., a video conference 120A). A video conference refers to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Video conference platform 120 can allow a user to join and participate in a video conference call with other users of the platform. Embodiments of the present disclosure can be implemented with any number of participants connecting via the video conference (e.g., up to one hundred or more).

The client devices 102A-102N may each include computing devices such as personal computers (PCs), laptops, mobile phones, smart phones, tablet computers, netbook computers, network-connected televisions, etc. In some implementations, client devices 102A-102N may also be referred to as “user devices.” Each client device 102A-102N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video stream) of the captured data of the captured images.

In some embodiments, video conference platform 120 is coupled, via network 104, with one or more client devices 104 that are each associated with a physical conference or meeting room. Client device(s) 104 may include or be coupled to a media system 132 that may comprise one or more display devices 136, one or more speakers 140 and one or more cameras 144. Display device 136 can be, for example, a smart display or a non-smart display (e.g., a display that is not itself configured to connect to network 104). Users that are physically present in the room can use media system 132 rather than their own devices (e.g., client devices 102A-102N) to participate in a video conference, which may include other remote users. For example, the users in the room that participate in the video conference may control the display 136 to show a slide presentation or watch slide presentations of other participants. Sound and/or camera control can similarly be performed. Similar to client devices 102A-102N, client device(s) 104 can generate audio and video data to be streamed to video conference platform 120 (e.g., using one or more microphones, speakers 140 and cameras 144).

Each client device 102A-102N or 104 can include a web browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access video conference platform 120. For example, a user of client device 102A can join and participate in a video conference via a UI 124A presented on the display device 103A by the web browser or client application. A user can also present a document to participants of the video conference via each of the UIs 124A-124N. Each of the UIs 124A-124N can include multiple regions to present visual items corresponding to video streams of the client devices 102A-102N provided to the server 130 for the video conference.

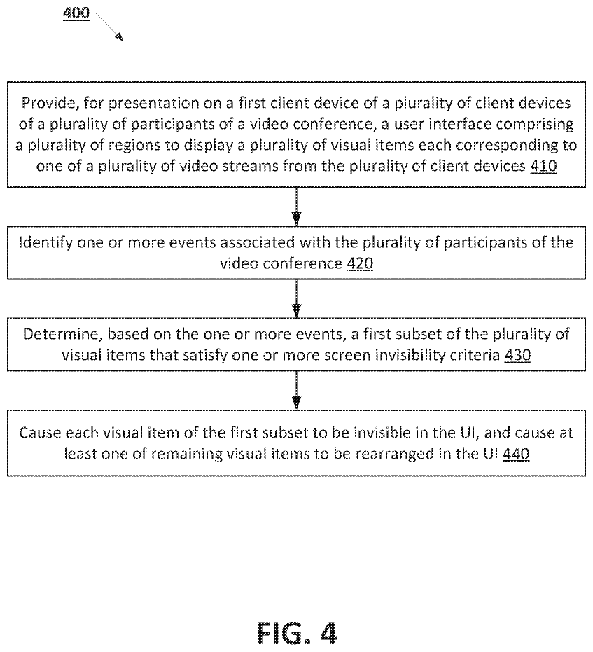

In some implementations, server 130 can include a video conference manager 122. Video conference manager 122 is configured to manage a video conference between multiple users of video conference platform 120. In some implementations, video conference manager 122 can provide the UIs 124A-124N to each client device to enable users to watch and listen to each other during a video conference. Video conference manager 122 can also collect and provide data associated with the video conference to each participant of the video conference. In some implementations, video conference manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device 104. The native application may be separate from a web browser. In some embodiments, the video conference manager 122 can determine visual items for presentation in the UI 124A-124N during a video conference. A visual item can refer to a UI element that occupies a particular region in the UI and is dedicated to presenting a video stream from a respective client device. Such a video stream can depict, for example, a user of the respective client device while the user is participating in the video conference (e.g., speaking, presenting, listening to other participants, watching other participants, etc., at particular moments during the video conference), a physical conference or meeting room (e.g., with one or more participants present), a document or media content (e.g., video content, one or more images, etc.) being presented during the video conference, etc. . . . For example, the video conference manager 122 can identify one or more events associated with the set of participants of the video conference (e.g., a detection of a low audio volume level, a detection of a high audio volume level, a detection of an audio mute signal, a user selection of a UI element such as to remove a visual item from the UI and/or to adjust a maximum number of visual items displayed in the UI and/or to pin a visual item in the UI, etc.). In response to identifying the one or more events, the video conference manager 122 can determine, based on the one or more events, a first subset of visual items that satisfy one or more screen invisibility criteria. As described in more detail with respect to FIG. 4, invisibility criteria can define conditions pertaining to the above events. Once the subset of visual items is identified, the video conference manager 122 can cause each visual item of the first subset to be invisible (e.g., removed or hidden) in the UI. In some embodiments, the video conference manager 122 can determine, based on the one or more events, another (e.g., a second) subset of visual items that do not satisfy the one or more screen invisibility criteria, as described in detail with respect to FIG. 4. Accordingly, the video conference manager 122 can modify a position or a size of one or more visual items of the second subset, such as to cause the one or more visual items of the second subset to be rearranged in the UI. Further details with respect to the video conference manager 122 are described with respect to FIG. 4.

As described previously, an audiovisual component of each client device can capture images and generate video data (e.g., a video stream) of the captured data of the captured images. In some implementations, the client devices 102A-102N and/or client device(s) 104 can transmit the generated video stream to video conference manager 122. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to video conference manager 122.

In some implementations, video conference platform 120 and/or server 130 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a video conference. Video conference platform 120 may also include a website (e.g., a webpage) or application back-end software that may be used to enable a user to connect with other users via the video conference.

It should be noted that in some other implementations, the functions of server 130 or video conference platform 120 may be provided by a fewer number of machines. For example, in some implementations, server 130 may be integrated into a single machine, while in other implementations, server 130 may be integrated into multiple machines. In addition, in some implementations, server 130 may be integrated into video conference platform 120.

In general, functions described in implementations as being performed by video conference platform 120 or server 130 can also be performed by the client devices 102A-N and/or client device(s) 104 in other implementations, if appropriate. In addition, the functionality attributed to a particular component can be performed by different or multiple components operating together. Video conference platform 120 and/or server 130 can also be accessed as a service provided to other systems or devices through appropriate application programming interfaces, and thus is not limited to use in websites.

Although implementations of the disclosure are discussed in terms of video conference platform 120 and users of video conference platform 120 participating in a video conference, implementations may also be generally applied to any type of telephone call or conference call between users. Implementations of the disclosure are not limited to video conference platforms that provide video conference tools to users.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel, of the video conference platform 120.

In situations in which the systems discussed here collect personal information about users, or may make use of personal information, the users may be provided with an opportunity to control whether video conference platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the video conference platform 120 and/or server 130.

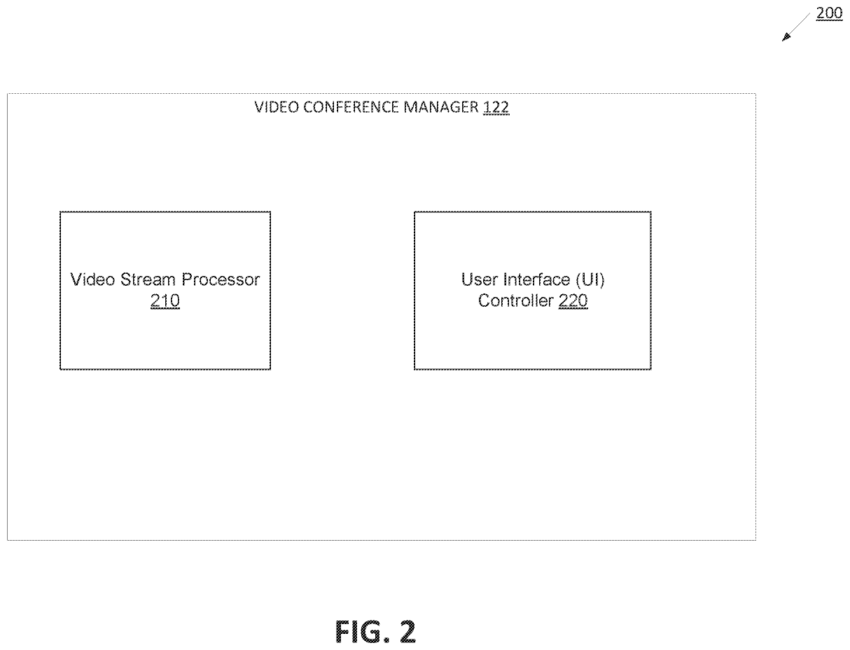

FIG. 2 is a block diagram illustrating an example video conference manager 122, in accordance with implementations of the present disclosure. The video conference manager 122 includes a video stream processor 210 and a user interface (UI) controller 220. The components can be combined together or separated into further components, according to a particular implementation. It should be noted that in some implementations, various components of the video conference manager 122 may run on separate machines.

The video stream processor 210 can receive video streams from the client devices (e.g., from client devices 102A-102N and/or 104). The video stream processor 210 can determine visual items for presentation in the UI (e.g., the UIs 124A-124N) during a video conference. Each visual item can correspond to a video stream from a client device (e.g., the video stream pertaining to one or more participants of the video conference). In some implementations, the video stream processor 210 can receive audio streams associated with the video streams from the client devices (e.g., from an audiovisual component of the client devices 102A-102N). Once the video stream processor has determined visual items for presentation in the UI (e.g., as described with respect to FIG. 4), the video stream processor 210 can notify the UI controller 220 of the determined visual items.

The UI controller 220 can provide the UI for a video conference. The UI can include multiple regions. Each region can display a video stream pertaining to one or more participant of the video conference. The UI controller 220 can control which video stream is to be displayed by providing a command to the client devices that indicates which video stream is to be displayed in which region of the UI (along with the received video and audio streams being provided to the client devices). For example, in response to being notified of the determined visual items for presentation in the UI 124A-124N, the UI controller 220 can transmit a command causing each determined visual item to be displayed in a region of the UI and/or rearranged in the UI. In some embodiments, the UI controller 220 can transmit a command causing another set of visual items to be invisible (e.g., removed or hidden) in the UI. Further details are described with respect to FIG. 4.

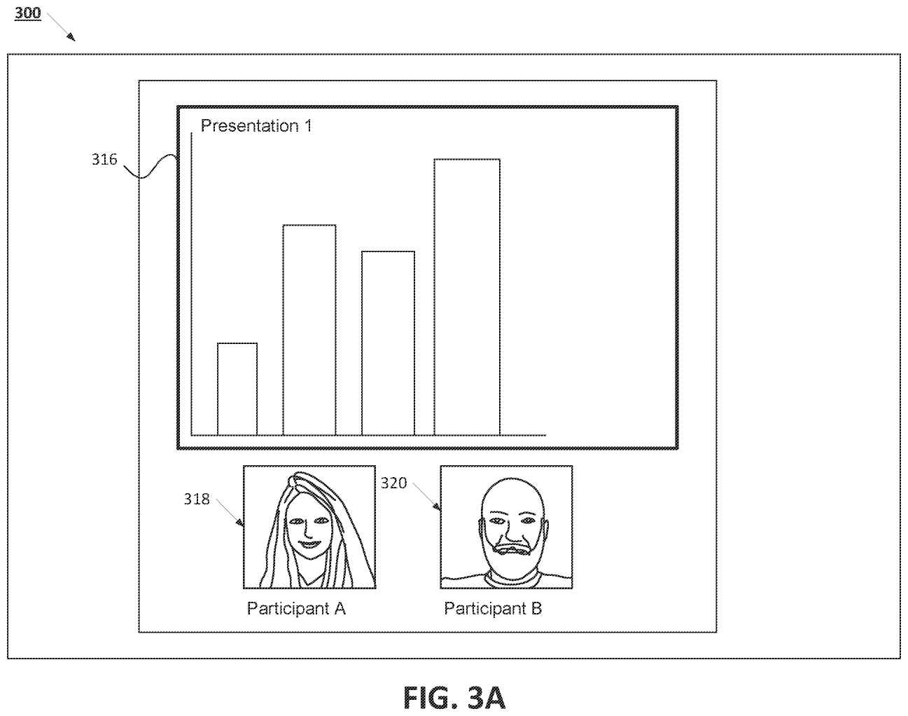

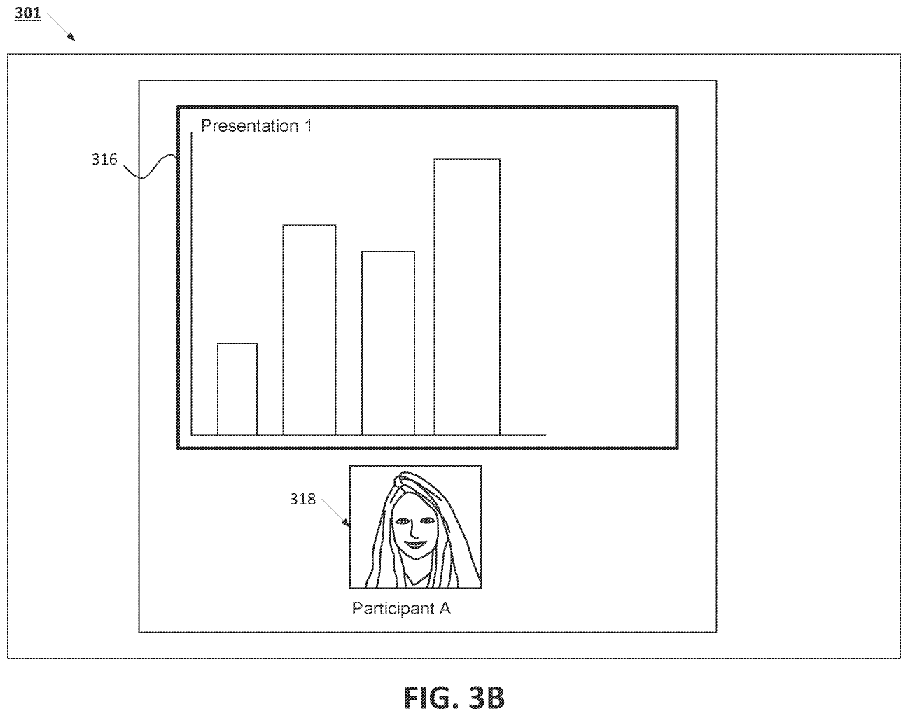

FIG. 3A illustrates an example user interface 300 for a video conference, in accordance with some embodiments of the present disclosure. The UI 300 can be generated by the video conference manager 122 of FIG. 1 for presentation at a client device (e.g., client devices 102A-102N and/or 104). Accordingly, the UI 300 can be generated by one or more processing devices of the server 130 of FIG. 1. In some implementations, the video conference between multiple participants can be managed by the video conference platform 120. As illustrated, the video conference manager 122 can provide the UI 300 to enable participants (e.g., participants A-C) to join and participate in the video conference.

UI 300 can include multiple regions, including a first region 316, a second region 318, and a third region 320. The first region 316 displays a visual item corresponding to video data (e.g., a video stream) of a document being presented. A document can be a slide presentation, a word document, a spreadsheet document, a web page, or any other document that can be presented. In one implementation, a client device can open (e.g., in response to a user operation) a document on the screen using an appropriate document application and share (e.g., in response to a user operation) the screen presenting the document with client devices of the other participants by providing a video stream of the document.

Second region 318 can display a visual item corresponding to video data captured and/or streamed by a client device associated with Participant A. Third region 320 can display a visual item corresponding to video data captured and/or streamed by a client device associated with Participant B. As illustrated, the first region 316 can correspond to a “main region,” e.g., an area in the UI 300 that is placed at or near the center or a focus area of the UI 300. In some embodiments, the second region 318 and the third region 320 can correspond to “thumbnail regions.” A thumbnail region can refer to an area of the UI 300 that can be located along a side (e.g., a bottom side) of the UI 300. Similar to the main region, the thumbnail region is also associated with a video stream received from the client device and displays the video stream. However, the thumbnail region spans a smaller area than the main region, thereby presenting images of the associated video stream in a relatively smaller scale than the main region.

In some embodiments, the first region 316 is relatively bigger than the second region 318 and the third region 320 to catch the attention of participants in the video conference (e.g., users of the client devices).

In some implementations, there can be more than one main region. In some implementations, each region is of the same or similar size as the size of each other region. In some implementations, the first region 316 can be used to display a video stream from a client device associated with an active and/or current speaker and/or presenter of the video conference.

In some implementations, the video conference manager 122 can associate each region with a visual item corresponding to a video stream received from a client device. For example, the processing device can determine that the second region 318 is to display a visual item corresponding to a video stream from the client device of Participant A (e.g., based on an identifier associated with each client device and/or each participant). In some implementations, this can be done automatically without any user input specifying which visual item is to be displayed in the second region 318 in the UI 300.

In some implementations, the UI 300 can also include an options region (not illustrated in FIG. 3A) for providing selectable options to adjust display settings (e.g., a size of each region, a number of regions, a selection of a video stream, etc.), invite additional users to participate, etc. In some implementations, the UI 300 can include a UI element (e.g., an icon) (not illustrated in FIG. 3A) that corresponds to a self-view indicator, which can indicate to a participant if the participant's video stream is displayed in a region in the UI. In some implementations, the UI 300 can include a UI element (e.g., a blinking circle or other shape) (not illustrated in FIG. 3A) that can indicate that a participant is about to be removed based on one or more of the set of timers associated with the participant, as described with respect to FIG. 4. In some implementations, the UI element to indicate that a participant is about to removed can be combined with the UI element corresponding to the self-view indicator, such as a blinking circle encircling an icon.

In some implementations, the processing device can determine each of the visual items for presentation in each region. For example, FIG. 3B illustrates another example user interface 301 of a video conference, in accordance with some embodiments of the present disclosure. In some implementations, the processing logic can identify one or more events associated with the set of participants (e.g., Participants A-B in FIG. 3A) of the video conference (e.g., a detection of a low audio volume level, a detection of a high audio volume level, a detection of an audio mute signal, a user selection of a UI element such as to remove a visual item from the UI and/or to adjust a maximum number of visual items displayed in the UI and/or to pin a visual item in the UI, etc.). In response to identifying the one or more events, the processing logic can determine, based on the one or more events, a first subset of visual items that satisfy one or more screen invisibility criteria, as described in detail with respect to FIG. 4. Accordingly, the processing logic can cause each visual item of the first subset to be no longer visible (e.g., get removed or hidden) in the UI. For example, the processing logic can determine that the visual item corresponding to a video stream of Participant B satisfies the one or more screen invisibility criteria (e.g., that the visual item for Participant B should be removed from and/or hidden in the UI). As illustrated in FIG. 3B, the visual item corresponding to the video stream of Participant B is no longer in the UI (e.g., the third region 320 is invisible in the UI). In some embodiments, the processing logic can determine, based on the one or more events, another (e.g., a second) subset of visual items that do not satisfy the one or more screen invisibility criteria, as described in detail with respect to FIG. 4. Accordingly, the video conference manager 122 can modify a position or a size of one or more of the second subset of visual items, such as to cause the one or more of the second subset of visual items to be rearranged in the UI. For example, the processing logic can determine that the visual item corresponding to the video stream of Participant A does not satisfy the one or more screen invisibility criteria. As illustrated, the position of the region displaying the visual item corresponding to the video stream of Participant A is modified (e.g., is moved to the bottom center of the UI below the first region 316).

In some implementations, the UI 301 can also include an options region (not illustrated in FIG. 3B) for providing selectable options to adjust display settings (e.g., a size of each region, a number of regions, a selection of a video stream, etc.), invite additional users to participate, etc.

FIG. 4 depicts a flow diagram of a method 400 for determining visual items for presentation in a user interface (UI) of a video conference, in accordance with implementations of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1 (e.g., video conference platform 120, server 130 and/or video conference manager 122).

For simplicity of explanation, the method 400 of this disclosure is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events. Additionally, it should be appreciated that the method 400 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 410, the processing logic provides, for presentation on a first client device (e.g., the client device 120A of FIG. 1) of a set (e.g., a plurality) of client devices (e.g., the client devices 120A-120N and/or 140 of FIG. 1) of a set of participants of a video conference, a user interface (UI) (e.g., a UI 124A of the UIs 124A-124N of FIG. 1). In some embodiments, the UI includes a set of regions to display a set of visual items, where each visual item corresponds to one of a set of video streams from the set of client devices. In some embodiments, a video stream can correspond to a series of images captured by a camera of a client device and subsequently encoded for transmission over a network in accordance with, for example, H.264 standard. In some embodiments, the video stream can correspond to screen image data of a document presented on a display device of a client device. A document can be a slide presentation, a word document, a spreadsheet document, a web page, or any other document that can be presented.

In some embodiments, each video stream can be associated with an audio stream corresponding to audio data collected by a microphone of a client device and subsequently encoded (e.g., compressed and packetized) for transmission over a network. The audio data can be encoded according to a standard such as MP3, etc. In some embodiments, the processing device can receive the audio streams and video streams as a composite stream. The composite stream is also referred to as a multiplex stream where segments of the audio streams and video streams are intermixed together.

At block 420, the processing logic identifies one or more events associated with the set of participants of the video conference.

In some embodiments, the one or more events can include, for example, a detection of a low audio volume level associated with a first client device of a first participant of the set of participants of the video conference. In some embodiments, detecting the low audio volume level associated with the first client device can include receiving an audio stream of an audio activity from the first client device (e.g., the client device 120A of FIG. 1) of the first participant (e.g., from an audiovisual component of the client device 120A as described with respect to FIG. 1). The processing logic can decode the received audio stream and extract audio data that corresponds to sound recorded by a microphone at the first client device of the first participant. The audio data can represent speech (e.g., spoken words). The processing logic can perform an audio detection algorithm (e.g., voice activity detection (VAD)) on the audio data to detect an audio volume level of the audio data, e.g., that the audio volume level is low. In some embodiments, a low audio volume level can be an audio volume level that is below a threshold audio volume. In other embodiments, the low audio volume level can be the lowest audio volume level among the client devices participating in the video conference. The threshold audio volume can be set using, for example, A/B testing. A/B testing, also known as split testing, can refer to a randomized experimentation process where two or more versions of a variable (e.g., an audio volume level) are shown to different groups (e.g., groups of users) at the same time, and their performance is compared. Thus, two or more audio volume levels can be shown to different groups for testing, and the results of the testing can determine the threshold audio volume below which an audio volume level is considered low to one or more of the different groups of users. In some embodiments, the threshold audio volume can be stored at the data store 110 of FIG. 1 and can be retrieved by the processing logic (e.g., by the video conference manager 122).

In some embodiments, the one or more events can include a detection of a high audio volume level associated with a first client device of a first participant of the set of participants. In some embodiments, detecting the high audio volume level can include receiving an audio stream of an audio activity from the first client device (e.g., the client device 120A of FIG. 1) of the first participant and/or audio streams of client devices from other participants in the set of participants. The processing logic can decode the received audio stream(s) and extract audio data that corresponds to sound recorded by a microphone at the respective client device. The audio data can represent speech (e.g., spoken words). The processing logic can perform an audio detection algorithm (e.g., voice activity detection (VAD)) on the audio data to detect an audio volume level of the audio data, e.g., that the audio volume level is high. In some embodiments, a high audio volume level can be an audio volume level that is above or equal to a threshold audio volume. As described above, the threshold audio volume can be set using, for example, A/B testing. In other embodiments, the high audio volume level can be the highest audio volume level among the client devices participating in the video conference.

In some embodiments, the one or more events include a detection of an audio mute signal. The audio mute signal can be received, for example, from a first client device of a first participant of the set of participants and/or a client device of a host (e.g., moderator) of the video conference. In some embodiments, detecting the audio mute signal can include detecting a selection (e.g., a user selection) of a UI element (e.g., a button) in the UI to mute the audio of a particular visual item.

In some embodiments, the one or more events can include a selection (e.g., a user selection) of a UI element (e.g., a button) to remove a visual item from the UI. In some embodiments, the one or more events can include a selection (e.g., a user selection) of a UI element (e.g., a button) to adjust a maximum number of visual items displayed in the UI. In some embodiments, the one or more events can include a selection (e.g., a user selection) of a UI element (e.g., a button) to “pin” a visual item in the UI.

At block 430, the processing logic determines, based on the one or more events identified at block 420, a first subset of the set of visual items that satisfy one or more screen invisibility criteria.

In some embodiments, the processing logic can identify, as described with respect to block 420, one or more events that include a detection of a low audio volume level associated with a first client device of a first participant of the set of participants. The processing logic can determine, based on the detected low audio volume level associated with the first client device of the first participant, whether a visual item corresponding to a video stream from the first client device satisfies the one or more screen invisibility criteria. For example, a screen invisibility criterion may include a condition that a detected low audio volume level associated with a client device continues to stay at a low level for at least a predefined period of time. The processing logic can determine that the detected low audio volume level associated with the first client device of the first participant satisfies this condition for the defined period of time. In some embodiments, the processing logic makes this determination based on a timer (e.g., a first timer of a set of timers) associated with the first client device of the first participant. The timer can be used for measuring a period of time during which the audio volume level associated with the first client device is below a threshold audio volume for the defined period of time. For example, in response to detecting the low audio volume level associated with the first client device of the first participant, the processing logic can set the timer (e.g., start the timer) to measure the period of time during which the audio volume level associated with the first client device of the first participant is below the threshold audio volume. For example, the defined period of time can be 15 seconds. If the audio volume level associated with the first client device is below the threshold audio volume for the defined period of time based on the timer, the processing logic can add a visual item corresponding to the video stream from the first client device to the first subset of visual items that satisfy the one or more screen invisibility criteria. As described above with respect to block 420, the threshold audio volume can be determined using A/B testing. In some embodiments, the defined period of time can be determined using A/B testing. For example, two or more versions of a variable (e.g., a period of time) are shown to different groups (e.g., groups of users) at the same time, and their performance is compared. Thus, two or more different periods of time can be shown to different groups for testing, and the results of the testing can determine the defined period of time for which the audio volume level of a participant (e.g., the first participant) is to satisfy the low audio volume criterion.

In some embodiments, the processing logic can identify, as described with respect to block 420, one or more events that include a detection of an audio mute signal initiated based on a command of a first participant. The processing logic can determine, based on the detected audio mute signal, whether a visual item corresponding to a video stream from the first client device satisfies the one or more screen invisibility criteria. For example, a screen invisibility criterion may include a condition that a detected audio mute signal initiated from a client device of a participant is not followed by an unmute signal for the audio of the client device of the participant for at least a predefined period of time. The processing logic can receive the audio mute signal from the first client device of the first participant of the set of participants. In response to receiving the audio mute signal, the processing logic can set a timer (e.g., a second timer of the set of timers) associated with the first client device of the first participant to initiate a countdown from an initial value. The processing logic can determine whether the timer reaches a threshold value while the audio of the first client device of the first participant remains muted (e.g., corresponding to the timer measuring a defined period of time from the initial value to the threshold value). For example, the timer can be set to initiate a countdown from 5 seconds to 0 seconds (e.g., a threshold time period of 5 seconds). In response to determining that the timer reaches the threshold value, the processing logic can add a visual item corresponding to the video stream from the first client device of the first participant to the first subset of visual items that satisfy the one or more screen invisibility criteria. In some embodiments, the initial value and the threshold value of the timer can be determined using A/B testing, as described herein. In some embodiments, the initial value of the timer can be a lower value than the initial value of the first timer (e.g., the timer described above with respect to measuring the period of time during which the audio volume level associated with the first participant is below the threshold audio volume).

In some embodiments, the processing logic can identify, as described with respect to block 420, one or more events that include a detection of an audio mute signal initiated from a client device of a host for a first client device of a first participant. The processing logic can determine, based on the detected audio mute signal, whether a visual item corresponding to a video stream from the first client device satisfies the one or more screen invisibility criteria. For example, a screen invisibility criterion may include a condition that a detected audio mute signal initiated from a client device of a host is not followed by an unmute signal for the audio of the client device of the participant from either the host or the participant for at least a predefined period of time. The processing logic can receive the audio mute signal from a host (e.g., a moderator) of the video conference. In response to receiving the audio mute signal, the processing logic can determine that the audio mute signal was initiated for a first client device of a first participant of the set of participants. The processing logic can set a timer (e.g., the second timer of the set of timers) associated with the first client of the first participant to initiate a countdown from an initial value. The processing logic can determine whether the timer reaches a threshold value while the audio of the first client device of the first participant remains muted. In response to determining that the timer reaches the threshold value, the processing logic can add a visual item corresponding to the video stream from the first client device to the first subset of visual items that satisfy the one or more invisibility criteria. The processing logic can reset the timer associated with the first client device. In some embodiments, the initial value and the threshold value of the timer can be determined using A/B testing, as described herein.

In some embodiments, the processing logic can identify, as described with respect to block 420, one or more events that include a selection of a UI element (e.g., a button) of a user of a first client device to remove a visual item from the UI. The processing logic can determine, based on the user selection of the UI element to remove the visual item from the UI, the visual item that satisfies the one or more screen invisibility criteria. For example, a screen invisibility criterion may include a condition that the visual item requested to be removed correspond to a participant who is currently not an active speaker. The processing logic can identify a participant associated with the visual item selected to be removed. In some embodiments, the processing logic can identify the participant associated with the visual item based on an identifier of the participant associated with the visual item. The processing logic can determine that an audio volume level associated with a client device of the identified participant is low and add a visual item corresponding to the video stream from the client device of the identified participant to the first subset of visual items that satisfy the one or more invisibility criteria.

In some embodiments, the processing logic can identify, as described with respect to block 420, one or more events that include a user selection of a UI element (e.g., a button) to adjust a maximum number of visual items displayed in the UI. The processing logic can determine, based on the user selection of the UI element to adjust a maximum number of visual items displayed in the UI, the first subset of the set of visual items that satisfy the one or more screen invisibility criteria. For example, the processing logic can determine that an audio volume level of an audio activity associated with the first client device of a first participant of the set of participants exceeds a threshold. In response to determining that the audio volume level of the first client device of the first participant exceeds the threshold, the processing logic can set a timer (e.g., a third timer of the set of timers) associated with the audio activity of the first client device to see how long the audio volume level of the first client device remains above the threshold. For a client device of each other participant of the set of participants, the processing logic can determine that an audio volume level of an audio activity of a client device of each other participant exceeds the threshold. In response to determining that the audio volume level of the client device of each other participant exceeds the threshold, the processing logic can set a timer associated with the audio activity of each respective client device of other participants to see how long the audio volume level of each respective client device remains above the threshold. The processing logic can compare a value (e.g., a current value) of the timer associated with the audio activity of the first client device to a value (e.g., a current value) of the timer associated with the audio activity of each respective client device of other participants. The processing logic can determine, based on the comparing, that the current value of the timer associated with the audio activity of the first client device is a lower value as compared to the current value of the timer associated with the audio activity of each respective client device of other participants. The processing logic can add a visual item corresponding to the video stream from the first client device to the first subset of visual items that satisfy the one or more invisibility criteria.

At block 440, the processing logic causes each visual item of the first subset of the set of visual items that satisfy the one or more screen invisibility criteria to be invisible in the UI. The processing logic also causes at least one of remaining visual items to be rearranged in the UI.

In some embodiments, causing each visual item of the first subset to be invisible in the UI can include causing each visual item of the first subset to become hidden on the UI. In some embodiments, causing each visual item of the first subset to be invisible in the UI can include causing each visual item of the first subset to be removed from the UI.

In some embodiments, causing the at least one of the remaining visual items to be rearranged in the UI can include increasing a size of a UI region displaying at least one of the remaining visual items to occupy at least a part of a region that displayed a visual item of the first subset that was caused to be invisible in the UI.

In some embodiments, causing the at least one of the remaining visual items to be rearranged in the UI can include determining a second subset of the set of visual items that do not satisfy the one or more screen invisibility criteria. The processing logic can modify a position or a size of one or more of the second subset of visual items in the UI. For example, the processing logic can move the position of the one or more visual items of the second subset to (or closer to) the center of the UI. For example, as illustrated in FIGS. 3A-3B, the position of the visual item corresponding to Participant A was moved from the bottom left of the UI in FIG. 3A to the bottom center of the UI in FIG. 3B. In another example, the processing logic can increase the size of the one or more visual items to occupy at least a part of a region that displayed a visual item of the first subset that was caused to be invisible in the UI.

In some embodiments, determining the second subset of the set of visual items that do not satisfy the one or more screen invisibility criteria can be based on one or more events associated with the set of participants of the video conference.

In some embodiments, for example, the processing logic can identify one or more events that include a detection of a high audio volume level associated with the set of participants. The processing logic can determine, based on the detection of the high audio volume level, the second subset of the set of visual items that do not satisfy the one or more screen invisibility criteria. For example, the processing logic can compare an audio volume level associated with a first client device of a first participant of the set of participants to an audio volume level associated with a client device of each other participant of the set of participants. The processing logic can determine, based on the comparing, that the audio volume level associated with the first client device is a highest audio volume level as compared to client devices of other participants in the set of participants and remains the highest audio volume level for a threshold period of time. In some embodiments, the processing logic determines that the audio volume level associated with the first participant is the highest audio volume level as compared to each other participant for the threshold period of time based on a timer (e.g., another timer of the set of timers) associated with the first client device. The timer can be used to measure a period of time during which the audio volume level associated with the first client device is higher than an audio volume level of a client device of each other participant of the set of participants. If the period of time measured by the timer exceed the threshold, the processing logic can add the visual item corresponding to the video stream from the first client device to the second subset of visual items. In some embodiments, the threshold period of time can be determined using A/B testing, as described herein. In some embodiments, the threshold period of time associated with the first participant can be increased (e.g., by a predefined amount, such as 1 second) in response to receiving an audio mute signal from the host, as described above.

In some embodiments, the processing logic can identify one or more events that include a selection (e.g., a user selection of a UI element (e.g., a button) to pin a visual item in the UI. The processing logic can determine, based on the selection to pin the visual item in the UI, that the pinned visual item does not satisfy the one or more screen invisibility criteria, and add this visual item to the second subset of visual items that do not satisfy the one or more screen invisibility criteria.

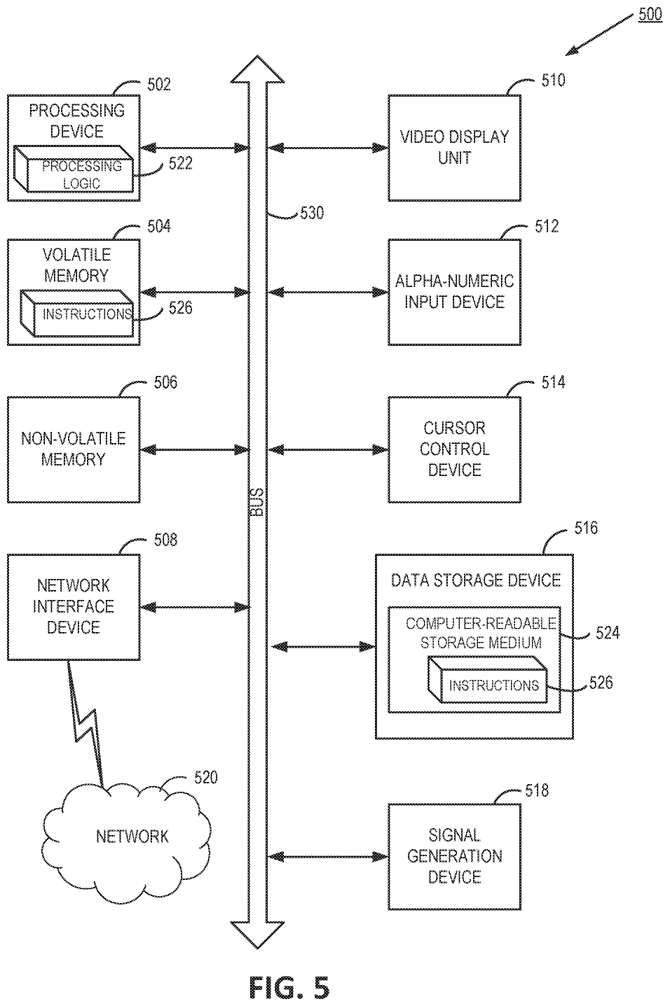

FIG. 5 is a block diagram illustrating an exemplary computer system, in accordance with implementations of the present disclosure. The computer system 500 can be the server 130 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 (e.g., for determining visual items for presentation in a user interface of a video conference) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory machine-readable storage medium 524 (also computer-readable storage medium) on which is stored one or more sets of instructions 505 (e.g., for determining visual items for presentation in a user interface of a video conference) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

In one implementation, the instructions 505 include instructions for determining visual items for presentation in a user interface of a video conference. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
providing, for presentation on a first client device of a plurality of client devices of a plurality of participants of a video conference, a user interface (UI) comprising a plurality of regions to display a plurality of visual items each corresponding to one of a plurality of video streams from the plurality of client devices;
identifying one or more events associated with the plurality of participants of the video conference;
determining, based on the one or more events, a first subset of the plurality of visual items that satisfy one or more screen invisibility criteria; and
causing each visual item of the first subset to be invisible in the UI, and causing at least one of remaining visual items to be rearranged in the UI.

2. The method of claim 1, wherein causing the at least one of the remaining visual items to be rearranged in the UI comprises:
increasing a size of a remaining region displaying the at least one of the remaining visual items to occupy at least a part of a region that displayed a visual item of the first subset that was caused to be invisible in the UI.

3. The method of claim 1, wherein the one or more events comprise detection of a low audio volume level associated with a first client device of the plurality of client devices, and wherein determining the first subset of the plurality of visual items that satisfy the one or more screen invisibility criteria comprises:
determining that an audio volume level associated with the first client device satisfies a low audio volume criterion for a defined period of time, wherein the determining is based on a timer associated with the first client device to measure a period of time during which the audio volume level associated with the first client device is below a threshold audio volume for the defined period of time; and
adding a visual item corresponding to the video stream from the first client device to the first subset.

4. The method of claim 1, wherein causing the at least one of the remaining visual items to be rearranged in the UI comprises:
determining a second subset of the plurality of visual items that do not satisfy the one or more screen invisibility criteria; and
modifying a position or a size of one or more of the second subset of the plurality of visual items.

5. The method of claim 4, wherein the one or more events comprise detection of a high audio volume level associated with the plurality of client devices, and wherein determining the second subset of the plurality of visual items that do not satisfy the one or more screen invisibility criteria comprises:
comparing an audio volume level associated with a first client device of the plurality of client devices to an audio volume level associated with each other client device of the plurality of client devices;
determining, based on the comparing, that the audio volume level associated with the first client device is a highest audio volume level as compared to each other client device of the plurality of client devices for a threshold period of time, wherein the determining is based on a timer associated with the first client device to measure a period of time during which the audio volume level associated with the first client device is higher than an audio volume level of each other client device of the plurality of client devices for the threshold period of time; and
adding a visual item corresponding to the video stream from the first client device to the second subset of the plurality of visual items.

6. The method of claim 1, wherein causing each visual item of the first subset to be invisible in the UI further comprises:
causing each respective region that displayed a visual item of the first subset to become hidden on the UI.

7. The method of claim 1, wherein causing each visual item of the first subset to be invisible in the UI further comprises:
causing each respective region that displayed a visual item of the first subset to be removed from the UI.

8. The method of claim 1, wherein the one or more events comprise detection of an audio mute signal, and wherein determining the first subset of the plurality of visual items that satisfy the one or more screen invisibility criteria comprises:
receiving the audio mute signal from a first client device of the plurality of client devices;
in response to receiving the audio mute signal, setting a timer associated with the first client device to initiate a countdown from an initial value;
in response to determining that the timer reaches a threshold value, adding a visual item corresponding to the video stream from the first client device to the first subset; and
resetting the timer associated with the first client device.

9. The method of claim 1, wherein the one or more events comprise detection of an audio mute signal, and wherein determining the first subset of the plurality of visual items that satisfy the one or more screen invisibility criteria comprises:
receiving the audio mute signal from a host of the video conference,
in response to receiving the audio mute signal:
identifying a first client device of the plurality of client devices associated with the audio mute signal; and
setting a timer associated with the first client device to initiate a countdown from an initial value;
in response to determining that the timer reaches a threshold value, adding a visual item corresponding to the video stream from the first client device to the first subset; and
resetting the timer associated with the first client device.

10. The method of claim 1, wherein the one or more events comprise a user selection of a UI element to remove a visual item from the UI, and wherein determining the first subset of the plurality of visual items that satisfy the one or more screen invisibility criteria comprises:
identifying a client device associated with the visual item selected to be removed; and
adding a visual item corresponding to the video stream from the identified client device to the first subset.

11. The method of claim 1, wherein the one or more events comprise a user selection of a UI element to adjust a maximum number of visual items displayed in the UI, and wherein determining the first subset of the plurality of visual items that satisfy the one or more screen invisibility criteria comprises:
responsive to determining that an audio volume level of an audio activity of a first client device of the plurality of client devices exceeds a threshold, setting a timer associated with the audio activity of the first client device;
for each other client device of the plurality of client devices, responsive to determining that an audio volume level of an audio activity of each other client device exceeds the threshold, setting a timer associated with the audio activity of each respective client device of each other client device;
comparing a current value of the timer associated with the audio activity of the first client device to a current value of the timer associated with the audio activity of each respective client device of each other client device;
determining, based on the comparing, that the current value of the timer associated with the audio activity of the first client device is a lower value as compared to the current value of the timer associated with the audio activity of each respective client device of each other client device; and
adding a visual item corresponding to the video stream from the first client device to the first subset.

12. The method of claim 4, wherein the one or more events comprise a user selection of a UI element to pin a visual item in the UI, and wherein determining the second subset of the plurality of visual items that do not satisfy the one or more screen invisibility criteria comprises:
identifying a client device associated with the visual item selected to be pinned; and
adding a visual item corresponding to the video stream from the identified client device to the second subset.

13. A system comprising:
a memory device; and
a processing device coupled to the memory device, the processing device to perform operations comprising:
providing, for presentation on a first client device of a plurality of client devices of a plurality of participants of a video conference, a user interface comprising a plurality of regions to display a plurality of visual items each corresponding to one of a plurality of video streams from the plurality of client devices;
identifying one or more events associated with the plurality of participants of the video conference;
determining, based on the one or more events, a first subset of the plurality of visual items that satisfy one or more screen invisibility criteria; and
causing each visual item of the first subset to be invisible in the UI, and causing at least one of remaining visual items to be rearranged in the UI.

14. The system of claim 13, wherein to cause the at least one of the remaining visual items to be rearranged in the UI, the processing device is to perform operations comprising:
increasing a size of a remaining region displaying the at least one of the remaining visual items to occupy at least a part of a region that displayed a visual item of the first subset that was caused to be invisible in the UI.

15. The system of claim 13, wherein the one or more events comprise detection of a low audio activity associated with a first client device of the plurality of client devices, and wherein to determine the first subset of the plurality of visual items that satisfy the one or more screen invisibility criteria, the processing device is to perform operations comprising:
determining that an audio volume level associated with the first client device satisfies a low audio volume criterion for a defined period of time, wherein the determining is based on a timer associated with the first client device to measure a period of time during which the audio volume level associated with the first client device is below a threshold audio volume for the defined period of time; and
adding a visual item corresponding to the video stream from the first client device to the first subset.

16. The system of claim 13, wherein to cause the at least one of the remaining visual items to be rearranged in the UI, the processing device is to perform operations comprising:
determining a second subset of the plurality of visual items that do not satisfy the one or more screen invisibility criteria; and
modifying a position or a size of one or more of the second subset of the plurality of visual items.

17. A non-transitory computer readable storage medium comprising instructions for a server that, when executed by a processing device, cause the processing device to perform operations comprising:
providing, for presentation on a first client device of a plurality of client devices of a plurality of participants of a video conference, a user interface comprising a plurality of regions to display a plurality of visual items each corresponding to one of a plurality of video streams from the plurality of client devices;
identifying one or more events associated with the plurality of participants of the video conference;
determining, based on the one or more events, a first subset of the plurality of visual items that satisfy one or more screen invisibility criteria; and
causing each visual item of the first subset to be invisible in the UI, and causing at least one of remaining visual items to be rearranged in the UI.

18. The non-transitory computer readable storage medium of claim 17, wherein to cause the at least one of the remaining visual items to be rearranged in the UI, the processing device is to perform operations comprising:
increasing a size of a remaining region displaying the at least one of the remaining visual items to occupy at least a part of a region that displayed a visual item of the first subset that was caused to be invisible in the UI.

19. The non-transitory computer readable storage medium of claim 17, wherein the one or more events comprise detection of a low audio activity associated with a first client device of the plurality of client devices, and wherein to determine the first subset of the plurality of visual items that satisfy the one or more screen invisibility criteria, the processing device is to perform operations comprising:
determining that an audio volume level associated with the first client device satisfies a low audio volume criterion for a defined period of time, wherein the determining is based on a timer associated with the first client device to measure a period of time during which the audio volume level associated with the first client device is below a threshold audio volume for the defined period of time; and
adding a visual item corresponding to the video stream from the first client device to the first subset.

20. The non-transitory computer readable storage medium of claim 17, wherein the one or more events comprise detection of an audio mute signal, and wherein to determine the first subset of the plurality of visual items that satisfy the one or more screen invisibility criteria, the processing device is to perform operations comprising:
receiving the audio mute signal from a first client device of the plurality of client devices;
in response to receiving the audio mute signal, setting a timer associated with the first client device to initiate a countdown from an initial value;
in response to determining that the timer reaches a threshold value, adding a visual item corresponding to the video stream from the first client device to the first subset; and
resetting the timer associated with the first client device.
